(19) United States
(12) Patent Application Publication
(10) Pub. No.: US 2011/0050422 A1
(43) Pub. Date: Mar. 3, 2011

(54) System and Method for Identifying Location of an Information Handling System

(75) Inventor: John Pflueger, Austin, TX (US)

(73) Assignee: DELL PRODUCTS L.P., Round Rock, TX (US)

(21) Appl. No.: 12/549,965

(22) Filed: Aug. 28, 2009

(51) Int. Cl. G08B 13/14

(52) U.S. Cl. 340/572.1

(57) ABSTRACT

Systems and methods for identifying the location of an information handling system are disclosed. A method may include placing a slot passive tag proximate to a corresponding slot, wherein the corresponding slot is configured to mechanically couple a corresponding information handling system to the slot and wherein the slot passive tag is configured to indicate its presence to a device placed substantially proximate to the slot passive tag. The method may also include placing an information handling system passive tag on a corresponding information handling system, such that when the corresponding information handling system is mechanically coupled to the slots, the information handling system passive tag is substantially proximate to the slot passive tag to which the information handling system is mechanically coupled, wherein the information handling system passive tag is configured to indicate its presence to the device placed substantially proximate to the information handling system passive tag.

### TECHNICAL FIELD

The present disclosure relates in general data center management, and more particularly to a system and method for identifying the location of an information handling system.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

One type of information handling system is a server. Servers are often self-contained information handling systems designed specifically to allow the placement of multiple servers in a single enclosure or aggregation of enclosures. A server enclosure or chassis may hold multiple servers and provide services to the various servers such as power, cooling, networking, interconnects, and management. For example, the chassis may include a plurality of power supply units configured to provide power to servers mounted in the chassis.

Often, multiple enclosures or chasses housing servers may be aggregated in the same room or building, which is sometimes referred to as a “data center.” Efficient management of such data centers often require an accurate understanding of the specific location of each server in the data center.

Traditionally, identifying a particular enclosure in which a server is located was a manual process, whereby an administrator would manually log the physical location of each server. Not only is such an approach time consuming, it also prone to human error.

More recent approaches have suggested combining radio-frequency identification (RFID)-tagged servers in combination with RFID readers on each enclosure. However, the high-cost of RFID readers often renders such a solution cost prohibitive.

Accordingly, an automated and cost-effective approach to identify locations of information handling systems in a data center environment is desired.

### SUMMARY

In accordance with the teachings of the present disclosure, disadvantages and problems associated with identifying the location of an information handling system have been substantially reduced or eliminated.

In accordance with one embodiment of the present disclosure, a system for identifying a location of an information handling system may include at least one enclosure having one or more slots, at least one slot passive tag, and at least one information handling system mechanically coupled to one of the one or more slots. Each slot may be configured to mechanically couple a corresponding information handling system to the enclosure. The at least one slot passive tag may be configured to indicate its presence to an external device placed substantially proximate to the slot passive tag, wherein each slot passive tag is located substantially proximate to a corresponding slot of the one or more slots. Each information handling system may having an information handling system passive tag configured to indicate its presence to the external device placed substantially proximate to the information handling system passive tag, wherein the information handling system passive tag is located substantially proximate to the slot passive tag corresponding to the slot for which the information handling system is mechanically coupled.

In accordance with another embodiment of the present disclosure, a method for identifying a location of an information handling system is provided. The method may include placing each of one or more slot passive tags proximate to a corresponding slot of one or more enclosures, wherein each corresponding slot is configured to mechanically couple a corresponding information handling system to the enclosure and wherein each of the one or more slot passive tags is configured to indicate its presence to an external device placed substantially proximate to the slot passive tag. The method may also include placing each of one or more information handling system passive tags on a corresponding information handling system, such that when the corresponding information handling system is mechanically coupled to one of the slots, the information handling system passive tag is substantially proximate to the slot passive tag of the particular slot to which the information handling system is mechanically coupled, wherein each of the one or more information handling system passive tags is configured to indicate its presence to an external device placed substantially proximate to the information handling system passive tag.

In accordance with a further embodiment of the present disclosure, another method for identifying a location of an information handling system is provided. The method may include placing each of one or more enclosure passive tags proximate to a corresponding enclosure of one or more enclosures, each of the one or more enclosures having one or more slots, wherein each slot is configured to mechanically couple a corresponding information handling system to the enclosure and wherein each of the one or more enclosure passive tags is configured to indicate its presence to an external device placed substantially proximate to the enclosure passive tag. The method may further include placing each of one or more information handling system passive tags on a corresponding information handling system, such that when the corresponding information handling system is mechanically coupled to one of the slots, the information handling system passive tag is substantially proximate to the slot passive tag of the particular slot to which the information handling system is mechanically coupled, wherein each of the one or more information handling system passive tags is configured to indicate its presence to an external device placed substantially proximate to the information handling system passive tag.

Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example system for identifying the location of one or more information handling systems, in accordance with embodiments of the present disclosure;

FIG. 2 illustrates a representation of an example asset database, in accordance with embodiments of the present disclosure;

FIG. 3 illustrates a representation of an example tag database, in accordance with embodiments of the present disclosure; and

FIG. 4 illustrates a representation of an example table depicting physical locations of information handling systems, in accordance with embodiments of the present disclosure.

### DETAILED DESCRIPTION

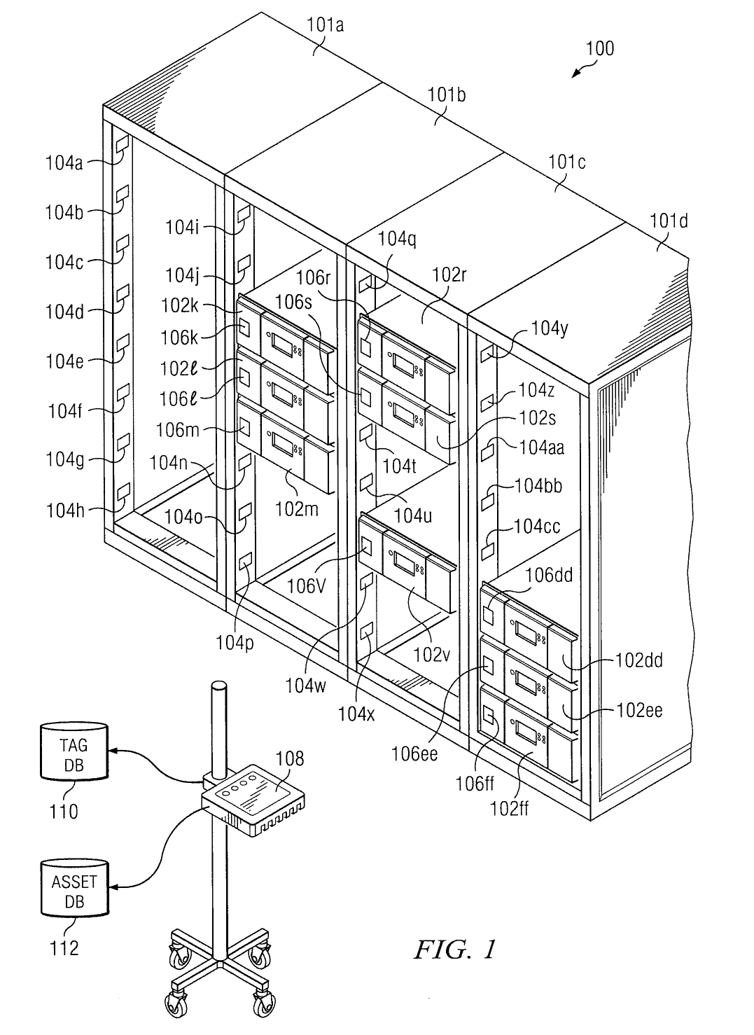

Preferred embodiments and their advantages are best understood by reference to FIGS. 1-4, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network storage device, or any other suitable device and may vary in size, shape, performance, functionality, and price. The information handling system may include memory, one or more processing resources such as a central processing unit (CPU) or hardware or software control logic. Additional components or the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory, as well as communications media such wires, optical fibers, microwaves, radio waves, and other electromagnetic and/or optical carriers; and/or any combination of the foregoing.

FIG. 1 illustrates a block diagram of an example system 100 for identifying the location of one or more information handling systems 102, in accordance with embodiments of the present disclosure. As shown in FIG. 1, system 100 may include one or more enclosures 101, one or more information handling systems 102, one or more passive tags 104, one or more passive tags 106, a mobile tag reader 108, a tag database 110, and an asset database 112.

Each enclosure 101 may include any device, system or apparatus that serves as a container for information handling systems 102 and/or other related components, and may be constructed from steel, aluminum, plastic, and/or any other suitable material. Although the term “enclosure” is used in this disclosure, each enclosure 101 may also be referred to as a rack, case, cabinet, tower, box, chassis, and/or housing. In certain embodiments, each enclosure 101 may be configured to hold and/or provide power to a plurality of information handling systems 102 and/or other related components (e.g., a “rack mount” system). Each enclosure 101 may include one or more slots or positions at which an information handling system 102 may be mechanically coupled to enclosure 101. Although FIG. 1 depicts each enclosure 101 as having eight slots (and thus, the capacity to house eight information handling systems 102), each enclosure 101 may have any suitable number of slots.

Each information handling system 102 may be mounted in a suitable slot and/or interface of an enclosure 101. In some embodiments, one or more of information handling systems 102 may be a server. As shown in FIG. 1, each information handling system 102 may have a particular location within system 100 which may be defined by the enclosure 101 housing the particular information handling system 102, and the particular slot (e.g., height) of the information handling system 102 within the enclosure 101.

As shown in FIG. 1, each enclosure 101 may include one or more passive tags 104. In some embodiments, each passive tag 104 may be placed proximate to a corresponding position, slot, and/or interface at which an information handling system 102 may be mounted within the enclosure 101. For example, if an enclosure is configured to house 24 information handling systems 102, the enclosure may include 24 passive tags 104 corresponding to the individual slots (e.g., heights) at which individual information handling systems 102 may be mounted. In other embodiments, each enclosure 101 may include a passive tag 104. Each passive tag 104 may be any system, device or apparatus that may transmit, communicate, or otherwise indicate its presence to an external sensor and/or reader proximate to the passive tag 104, but is generally not able to transmit, communicate, or otherwise indicate its presence autonomously if not proximate to an external sensor and/or reader. For example, in some embodiments, one or more of passive tags 104 may include a passive radio-frequency identification (RFID) tag, wherein the RFID tag transmits a radio-frequency signal to indicate its presence in response to a received radio-frequency signal (e.g., from an RFID reader), but may not autonomously transmit a presence signal in the absence of a received signal. In the same or alternative embodiments, one or more of passive tags 104 may be a magnet, wherein the presence of the magnet may be detected by an appropriate sensor (e.g., a Hall effect sensor). So that each passive tag 104 may appropriately identify the enclosure 101 in which it resides and/or its slot within such enclosure 101, each passive tag 104 may have its own unique identifier.

Similarly, each information handling system 102 may include one or more passive tags 106 applied to or otherwise incorporated within such information handling systems 102. Each passive tag 106 may be any system, device or apparatus that may transmit, communicate, or otherwise indicate its presence to an external sensor and/or reader proximate to the passive tag 106, but is generally not able to transmit, communicate, or otherwise indicate its presence autonomously if not proximate to an external sensor and/or reader. For example, in some embodiments, one or more of passive tags 106 may include a passive radio-frequency identification (RFID) tag, wherein the RFID tag transmits a radio-frequency signal to indicate its presence in response to a received radio-frequency signal (e.g., from an RFID reader), but may not autonomously transmit a presence signal in the absence of a received signal. In the same or alternative embodiments, one or more of passive tags 106 may be a magnet, wherein the presence of the magnet may be detected by an appropriate sensor (e.g., a Hall effect sensor). So that each passive tag 106 may appropriately identify the information handling system 102 in which it is associated, each passive tag 106 may have its own unique identifier. In some embodiments, passive tags may be identical or similar to passive tags 104.

Mobile tag reader 108 may include any system, device, or apparatus configured to detect the presence of a passive tag 104 and/or passive tag 106 in proximity with the mobile tag reader 108. For example, in some embodiments mobile tag reader 108 may comprise an RFID reader that transmits a radio-frequency signal that, when received by a passive tag 104 and/or a passive tag 106 in proximity to the mobile tag reader 108, causes the receiving passive tag 104 and/or passive tag 106 to respond with a radio-frequency signal, thus indicating the presence of the passive tag 104 and/or passive tag 106 to the mobile tag reader 108. As another example, in some embodiments mobile tag reader 108 may comprise a Hall effect sensor that when in proximity to a passive tag 104 and/or a passive tag 106, senses a magnetic field of passive tag 104 and/or passive tag 106, thus indicating the presence of the passive tag 104 and/or passive tag 106 to the mobile tag reader 108.

Mobile tag reader 108 may be moved about system 100 either manually or automatically. For example, in some embodiments, mobile tag reader 108 may be a “handheld” device such that an administrator or other person may move or swipe the mobile tag reader 108 proximate to passive tags 104 and/or passive tags 106. As another example, mobile tag reader 108 may be mounted to a robot, automated vehicle, and/or other device that may cause mobile reader to be moved or swiped proximate to passive tags 104 and/or passive tags 106.

In operation, passive tags 104 and passive tags 106 may be located such that when an information handling system 102 is mounted or placed in a particular slot in an enclosure 101, the passive tag 106 associated with the information handling system 102 may be substantially proximate to the passive tag 104 associated with the enclosure 101 and the particular slot at which the information handling system 102 is mounted within the enclosure 101. Accordingly, if mobile tag reader 108 is placed in proximity to a passive tag 106, it may detect the presence of the passive tag 106 and substantially simultaneously detect the presence of the passive tag 104 proximate to passive tag 106. Thus, whenever mobile tag reader 108 detects the presence of a passive tag 104 within a certain time threshold of detecting the presence of a passive tag 106, such substantially simultaneous detection may indicate that the passive tag 104 and passive tag 106 are in proximity, and consequently also provide an indication that the information handling system 102 associated with the passive tag 106 is located in the enclosure and/or at the enclosure slot associated with passive tag 104.

In embodiments in which an enclosure 101 includes only one passive tag 104, a slot position of an information handling system 102 may be detected where mobile reader 108 detects a passive tag 106 within a certain time interval of detection of the passive tag 104. In such embodiments, the time difference between detection of a passive tag 104 and a passive tag 106 may be indicative of the slot position of the information handling system 102 associated with the passive tag 106.

In order to determine the location of the various information handling systems 102 of system 100, mobile tag reader 108 may be swiped, manually and/or automatically, proximate to each passive tag 104. By analyzing response patterns from passive tags 104 and passive tags 106, individual passive tags 104 may be associated with individual passive tags 106, and stored in a database, such as asset database 112, for example.

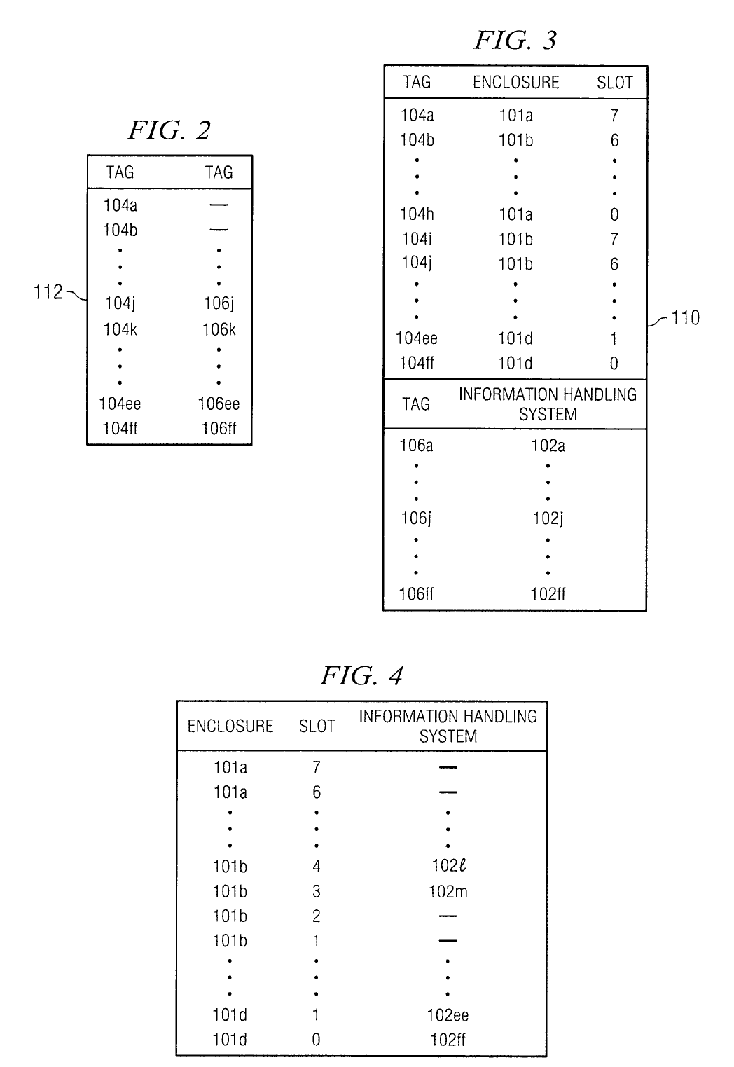

FIG. 2 illustrates a representation of an example of asset database 112, in accordance with embodiments of the present disclosure. Asset database 112 may include any table, list, record and/or other suitable data structure which includes regarding each passive tag 104 and any passive tag 106 associated with such passive tag 104. In some embodiments, asset database 112 may be embodied in a computer-readable medium. In the same or alternative embodiments, asset database 112 may be communicatively coupled to mobile tag reader 108 and/or one or more information handling systems 102.

As depicted in FIG. 2, asset database 112 may associate each passive tag 104 with a respective passive tag 106 substantially proximate to the passive tag 104. For example, as seen in FIG. 2, passive tag 104j is associated with passive tag 106j, thus indicating that passive tag 104j and passive tag 106j are located substantially proximate to each other. As another example, as seen in FIG. 2, passive tag 104a is not associated with a passive tag 106, thus indicating that no passive tag 106 is substantially proximate to passive tag 104a.

Based on information collected by mobile tag reader 108 (e.g., information stored in asset database 112), the physical location of individual information handling systems 102 may be determined by analyzing such collected information in conjunction with the associations among passive tags 104 and their slots within enclosures 101 and the associations among passive tags 106 and their associated information handling systems 102. Such enclosure-tag associations and information handling system-tag associations may be maintained in a tag database 110. Tag database 110 may include any table, list, record and/or other suitable data structure which includes: (a) data regarding each passive tag 104 and the individual enclosure 101 housing the passive tag 104 and/or the slot (e.g., height) of such passive tag 104 within an enclosure 101; and/or (b) data regarding each passive tag 106 and the individual information handling system 102 associated with such passive tag 106. In some embodiments, tag database 110 may be embodied in a computer-readable medium. In the same or alternative embodiments, tag database 110 may be communicatively coupled to mobile tag reader 108 and/or one or more information handling systems 102.

FIG. 3 illustrates a representation of an example of tag database 110, in accordance with embodiments of the present disclosure. As depicted in FIG. 3, tag database 110 may associate each tag 104 with a respective enclosure 101 and slot within such enclosure 101. For example, as shown in FIG. 3, passive tag 104h is associated with slot 0 of cabinet 101a, thus indicating the location of passive tag 104h in system 100. As another example, as shown in FIG. 3, passive tag 106j is associated with information handling system 102j, thus indicating that passive tag 106j is applied to and/or incorporated within information handling system 102j.

Mobile tag reader 108 and/or one or more of information handling systems 102 may be configured to read information stored in tag database 110 and asset database 112 and determine the physical location of each information handling system 102. For example, by analyzing information indicating that: (a) passive tag 104j is substantially proximate to passive tag 106j, (b) passive tag 104j is associated with slot 6 of enclosure 101b, and (c) passive tag 106j is associated with information handling system 102j, mobile tag reader 108 and/or one or more of information handling systems 102 may determine that information handling system 102j is located at slot 6 of enclosure 101b. In addition to determining individual physical locations of information handling systems 102, mobile tag reader 108 and/or one or more of information handling systems 102 may be configured to create a file, table, database, or other suitable structure setting forth the identity of the various information handling systems 102 located at each slot within enclosures 101, such as the table set forth in FIG. 4, for example. Such physical location information may be used to manage system 100 (e.g., verification and updating of data center applications, asset management services, providing input to computational fluids dynamics application or other system environmental analysis application).

Using the methods and systems disclosed herein, problems associated conventional approaches identifying the location of an information handling system have been reduced or eliminated. For example, the methods and systems disclosed may allow for the use of low-cost passive tags in conjunction with one or a small number of passive tag readers in order to identify the locations of various information handling systems in a data center or enterprise, and accordingly providing a lower-cost solution as compared to traditional approaches.

Although the present disclosure has been described in detail, it should be understood that various changes, substitutions, and alterations can be made hereto without departing from the spirit and the scope of the invention as defined by the appended claims.

What is claimed is:

1. A system for identifying a location of an information handling system, comprising:
at least one enclosure having one or more slots, wherein each slot is configured to mechanically couple a corresponding information handling system to the enclosure; and
at least one slot passive tag configured to indicate its presence to an external device placed substantially proximate to the slot passive tag, wherein each slot passive tag is located substantially proximate to a corresponding slot of the one or more slots; and
at least one information handling system mechanically coupled to one of the one or more slots, each information handling system having an information handling system passive tag configured to indicate its presence to the external device placed substantially proximate to the information handling system passive tag, wherein the information handling system passive tag is located substantially proximate to the slot passive tag corresponding to the slot for which the information handling system is mechanically coupled.

2. The system of claim 1, wherein the at least one slot passive tag is one of a passive radio-frequency identification tag and a magnet.

3. The system of claim 1, wherein the information handling system passive tag is one of a passive radio-frequency identification tag and a magnet.

4. The system of claim 1, further comprising a mobile tag reader configured to detect the presence of one or more slot passive tags and information handling system passive tags in substantial proximity with the mobile tag reader.

5. The system of claim 4, the mobile tag reader configured to determine the position of the at least one information handling system by determining whether the information handling system passive tag corresponding to the at least one information handling system and the slot passive tag corresponding to a particular slot are detected substantially simultaneously.

6. The system of claim 1, wherein the at least one information handling system comprises a server.

7. A method for identifying a location of an information handling system, comprising:
placing each of one or more slot passive tags proximate to a corresponding slot of one or more enclosures, wherein each corresponding slot is configured to mechanically couple a corresponding information handling system to the enclosure and wherein each of the one or more slot passive tags is configured to indicate its presence to an external device placed substantially proximate to the slot passive tag; and
placing each of one or more information handling system passive tags on a corresponding information handling system, such that when the corresponding information handling system is mechanically coupled to one of the slots, the information handling system passive tag is substantially proximate to the slot passive tag of the particular slot to which the information handling system is mechanically coupled, wherein each of the one or more information handling system passive tags is configured to indicate its presence to an external device placed substantially proximate to the information handling system passive tag.

8. The method of claim 7, wherein at least one of the one or more slot passive tags is one of a passive radio-frequency identification tag and a magnet.

9. The method of claim 7, wherein at least one of the one or more information handling system passive tags is one of a passive radio-frequency identification tag and a magnet.

10. The method of claim 7, further comprising scanning a mobile tag reader proximate to at least one of the one or more slot passive tags, wherein the mobile tag reader is configured to detect the presence of one or more slot passive tags and information handling system passive tags in substantial proximity with the mobile tag reader.

11. The method of claim 10, further comprising determining if the mobile tag reader has substantially simultaneously detected the presence of one of the one or more slot passive tags and one of the one or more information handling system passive tags.

12. The method of claim 11, wherein the substantially simultaneous detection of the presence of one of the one or more slot passive tags and one of the one or more information handling system passive tags indicates that the information handling system corresponding with the detected information handling system passive tag is mechanically coupled to the slot corresponding to the slot passive tag.

13. The method of claim 7, wherein the at least one information handling system comprises a server.

14. A method for identifying a location of an information handling system, comprising:
placing each of one or more enclosure passive tags proximate to a corresponding enclosure of one or more enclosures, each of the one or more enclosures having one or more slots, wherein each slot is configured to mechanically couple a corresponding information handling system to the enclosure and wherein each of the one or more enclosure passive tags is configured to indicate its presence to an external device placed substantially proximate to the enclosure passive tag; and
placing each of one or more information handling system passive tags on a corresponding information handling system, such that when the corresponding information handling system is mechanically coupled to one of the slots, the information handling system passive tag is substantially proximate to the slot passive tag of the particular slot to which the information handling system is mechanically coupled, wherein each of the one or more information handling system passive tags is configured to indicate its presence to an external device placed substantially proximate to the information handling system passive tag.

15. The method of claim 14, wherein at least one of the one or more enclosure passive tags is one of a passive radio-frequency identification tag and a magnet.

16. The method of claim 14, wherein at least one of the one or more information handling system passive tags is one of a passive radio-frequency identification tag and a magnet.

17. The method of claim 14, further comprising scanning a mobile tag reader proximate to at least one of the one or more enclosure passive tags, wherein the mobile tag reader is configured to detect the presence of one or more slot passive tags and information handling system passive tags in substantial proximity with the mobile tag reader.

18. The method of claim 17, further comprising determining if the mobile tag reader has detected the presence of one of the one or more enclosure passive tags and one of the one or more information handling system passive tags within a particular time interval.

19. The method of claim 18, wherein the detection of the presence of one of the one or more enclosure passive tags and one of the one or more information handling system passive tags indicates that the information handling system corresponding with the detected information handling system passive tag is mechanically coupled to the enclosure corresponding to the enclosure passive tag.

20. The method of claim 18, wherein a difference in time between the detection of the presence of one of the one or more enclosure passive tags and one of the one or more information handling system passive tags indicates that the information handling system corresponding with the detected information handling system passive tag is mechanically coupled to a particular slot of the enclosure corresponding to the enclosure passive tag.
